(19) United States
(12) Patent Application Publication
(10) Pub. No.: US 2009/0309850 A1
(43) Pub. Date: Dec. 17, 2009

(54) CAPACITIVE TOUCH PANEL

(76) Inventor: Kai-Ti Yang, Taoyuan (TW)

Correspondence Address: Kai-Ti Yang, 235 Chung - Ho, Box 8-24, Taipei, TW

(21) Appl. No.: 12/140,258

(22) Filed: Jun. 16, 2008

(51) Int. Cl. G06F 3/044

(52) U.S. Cl. 345/174

(57) ABSTRACT

A capacitive touch panel is assembled by a substrate layer, sensing layer, and surface layer. A plurality of transparent X and Y axis traces are arranged on the sensing layer and intersect each other as a matrix. A front end of each X trace and each Y trace has a joint. The plurality of X axis traces and Y axis traces are arranged at the same plane. Each X axis trace includes a plurality of induction-spots and each Y axis trace includes a plurality of induction-spots. The induction-spots of one X axis trace are connected one by one, while the induction-spots of one Y axis trace are formed separately with gaps. The adjacent induction-spots of Y axis trace are connected by a bridge structure and the induction-spots of the Y axis trace are insulated to the respective one of the plurality of X axis trace.

### FIELD OF THE PRESENT INVENTION

The present invention relates to capacitive touch panels, and in particular to a capacitive touch panel with X and Y axis traces formed on the same plane.

### DESCRIPTION OF THE PRIOR ART

A prior capacitive touch panel structure includes an X axis sensing layer and a Y axis sensing layer and both of them are arranged inside the touch panel and insulated from each other. The X and Y sensing layers are grounded and connected to a control circuit respectively. When operating, an instant capacity effect is generated by a conductor or a user's finger touch so that the position being touched will be located by detection of the variation of capacitance. The capacitive touch panel is capable of being operated by human finger, and therefore, it is convenient for an input operation. The panel will not repeatedly sustain stress and then deforms and it damaged because an input is performed without strongly pressing on the panel. Moreover, the assembly of the capacitive touch panel is simple, the components needed are few, and production yield is high. Thus, it is suitable for mass production to lower the cost. However, in the prior capacitive touch panel, the X and Y axis sensing traces are formed on two different layers. When assembling the X and Y sensing traces of the two different layers, a misalignment is happened and the sensitivity and precision of the sensing signal of the capacity will be damaged.

### SUMMARY OF THE PRESENT INVENTION

Accordingly, the present invention provides a touch panel structure with the X and Y axis traces in a same plane so as the traces can be formed more precisely to improve the sensitivity and the precision of the sensing effect.

To achieve above object, the present invention provides a capacitive touch panel having a substrate layer, a sensing layer and a surface layer, a sensing layer and a surface layer being made of transparent material and being glued together as a transparent panel; a plurality of X axis traces and a plurality of Y axis traces being intersected each other and arranged on the sensing layer so as to form as a matrix on the sensing layer; a front end of each X trace and each Y trace having a joint which is connected to a sliver conducting wire at edges of the panel and is conducted to a signal output wire bank; therefore, an output signal of the touch panel being transferred through the signal output wire bank to a succeeding signal processing circuit.

The plurality of X axis traces and Y axis traces are arranged at the same plane; each X axis trace includes a plurality of induction-spots and each Y axis trace includes a plurality of induction-spots; the induction-spots of one X axis trace are connected one by one, while the induction-spots of one Y axis trace are connected by a bridge structure running through a respective one of the plurality of X axis traces and the induction-spots of the Y axis trace is insulated to the respective one of the plurality of X axis trace.

The bridge structure includes a shielding film and a conductive wire; the shielding film is an insulated thin film, and the shielding film will cover at least an area of the X axis trace between the two adjacent induction-spots of one Y axis trace; the conductive wire is arranged on the surface of the shielding film; both ends of the conductive wire extend outside the shielding film to the adjacent induction-spots respectively and form as electrical joints; by the shielding film arranged between the two adjacent induction-spots of the Y axis trace, the X axis trace which passes between the two adjacent induction-spots of the Y axis trace will be covered and insulated; and the electrical joints on the two ends of the conductive wire will connect the two adjacent induction-spots respectively so as all the induction-spots of each Y axis trace are connected by the bridge structures.

The bridge structure includes a shielding film and a conductive wire; the shielding film is an insulated thin film; and the shielding film will cover at least partially any two adjacent induction-spots of each Y axis trace; furthermore, at least two through holes are formed on the shielding film respectively to the adjacent induction-spots; the conductive wire is arranged on a surface of the shielding film and crosses a position between the two through holes; both ends of the conductive wire exposed to the through holes respectively are formed as electrical joints; by the shielding film arranged between the two adjacent induction-spots of one Y axis trace, the X axis trace which passes between the two adjacent induction-spots of the Y axis trace will be covered and insulated; and the electrical joints on the two ends of the conductive wire will be connected to the two adjacent induction-spots through the through holes respectively so that all the induction-spots of each Y axis trace are connected by the bridge structures.

The various objects and advantages of the present invention will be more readily understood from the following detailed description when read in conjunction with the appended drawing.

### BRIEF DESCRIPTION OF THE DRAWINGS

FIG. 1 is a schematic view showing the X and Y axis traces on a sensing layer.

FIG. 2 is a partially enlarged prospective view showing a bridge structure on the sensing layer of the first embodiment of the present invention.

FIG. 3 is a cross section view along the line C-C of the FIG. 2.

FIG. 4 is a partially enlarged prospective view showing a bridge structure on the sensing layer of another embodiment of the present invention.

FIG. 5 is a cross section view along the D-D line of the FIG. 4.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

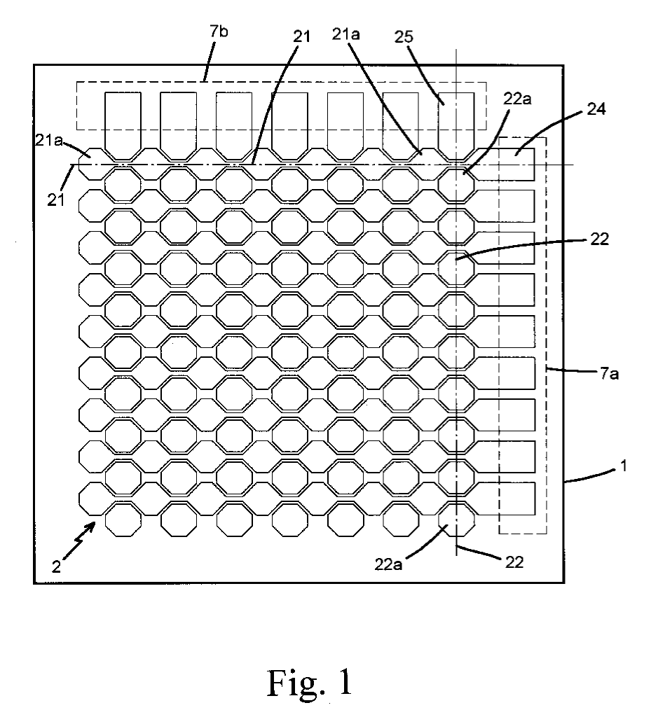

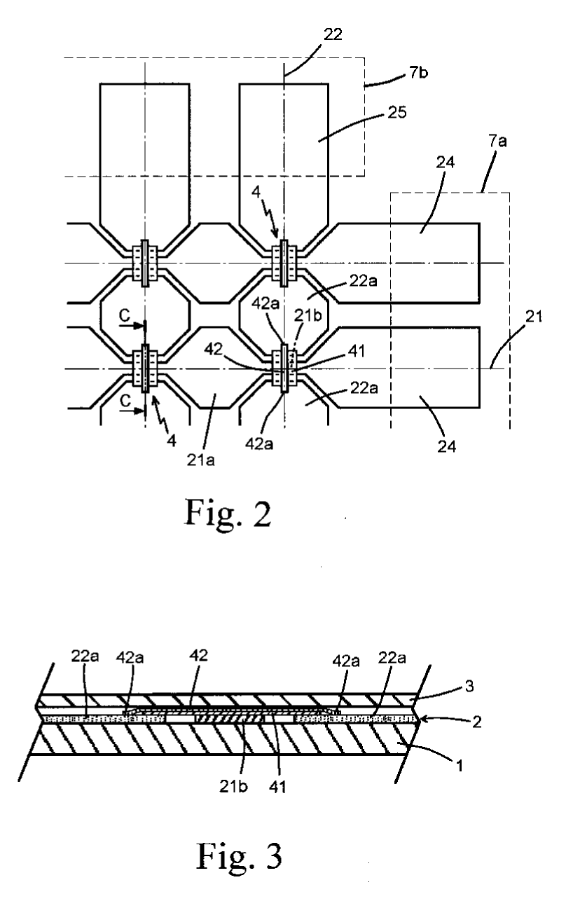

As shown in FIGS. 1 to 3, the first embodiment shown in the figures is a capacitive touch panel made of a transparent panel and the panel consists of a substrate layer 1, sensing layer 2, surface layer 3, and a bridge structure 4. The substrate layer 1 and the surface layer 3 are insulated thin panels with highly transparent property such as a material of glass, Polycarbonate (PC), Polythylene terephthalate (PET), Polymethylmethacrylate (PMMA), or Cyclic Olefin Copolymer. The sensing layer 2 is made of a transparent conductive film such as an Indium Tin Oxide film, or a transparent organic conductive film such as Poly ethylenedioxythiophene (PEDOT). The sensing layer 2 is arranged between the substrate layer 1 and the surface layer 3 and includes a plurality of transparent X axis traces 21 which are arranged in parallel with a fixed interval between, and also includes a plurality of transparent Y axis traces 22 which are arranged in parallel with a fixed interval between. The X and Y traces 21, 22 intersect with each other as a matrix. Induction-spots 21a are formed on each X axis trace 21 and are connected one by one, and induction-spots 22a are formed on each Y axis trace but are formed separately with gaps. The widths of the traces 21 and 22 are usually about 0.05 to 5 mm. An end of each X axis trace 21 is formed as a trace joint 24, and an end of each Y axis trace 22 is formed as a trace joint 25. The trace joints 24 and 25 can respectively connect to sliver conducting wires 7a and 7b formed at the panel edges near the trace joints 24 and 25 and then conduct to a signal output wire bank (not shown). Through above connections, a sensing signal generated by the X axis traces 21 and Y axis traces 22 on the sensing layer 2 can be transmitted to a succeeding signal processing circuit (not shown) through the signal output wire bank. Furthermore, in accordance with FIGS. 2 and 3, the mentioned bridge structure 4 includes a shielding film 41 and a conductive wire 42. The shielding film 41 is made of a material of highly transparent insulated thin film with permittivity between 2 and 4 such as ink or PET mentioned above. The shielding film 41 will cover at least an X axis trace 21b which is an area of the X axis trace 21 between two adjacent induction-spots 22a of the Y axis trace 22. The conductive wire 42 is made of a transparent organic conductive material such as Indium Tin Oxide and PEDOT and is arranged on the surface of the shielding film 41. Both ends of the conductive wire 42 extend outside the shielding film 41 to the adjacent induction-spots 22a respectively and form as electrical joints 42a. When the bridge structure 4 is arranged on the sensing layer 2, the shielding film 41 will be arranged between each two adjacent induction-spots 22a of the Y axis traces and cover and insulate the X axis trace 21b which is located between the two adjacent induction-spots 22a of the Y axis trace. Moreover, the electrical joints 42a on the two ends of the conductive wire 42 will connect the two adjacent induction-spots 22a respectively so that all the induction-spots 22a of each Y axis trace 22 are connected by the bridge structures 4. That is, the X axis traces 21 and Y axis traces 22 are arranged on the surface of the same sensing layer 2 but independent from each other.

In the above mentioned structure, an equivalent capacity is formed between the X axis trace 21 and the silver conducting wire 7a, and also between the Y axis trace 22 and the silver conducting wire 7b. When a finger or a conductor touches or slides on a certain position on the surface of the touch panel, the signal processing circuit can locate the position by the variation of the capacitance. Therefore, the transparent touch panel of the present invention can be arranged in front of the screen of an electronic product so that a user can easily perform an input by finger touch under the instruction displayed on the screen. Moreover, the X axis traces and the Y axis traces of the capacitive touch panel of the present invention are arranged precisely because both of those are formed on the same plane. Thus, the sensitivity and the precision of the sensing signal of capacity are improved.

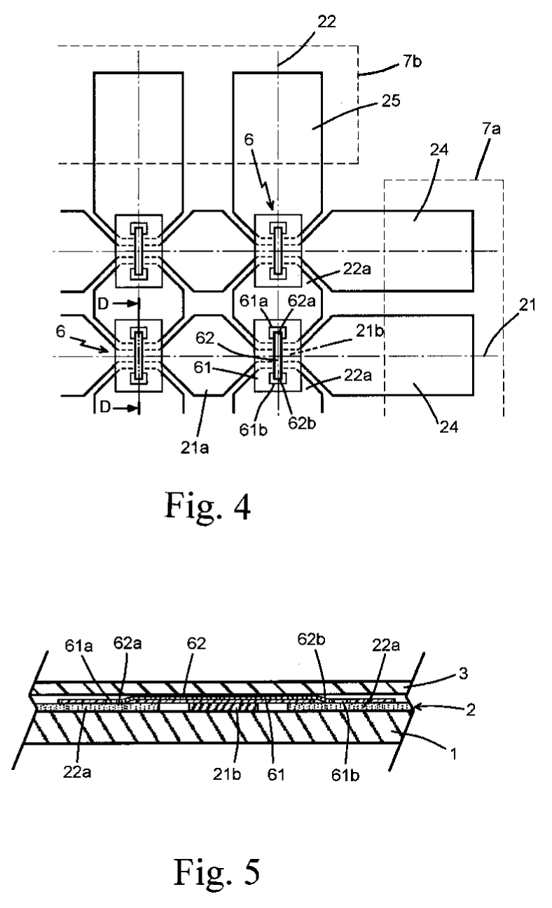

Moreover, as shown in FIGS. 4 and 5, a second embodiment of the present invention is approximately same as the first embodiment but having a different bridge structure. In the second embodiment of the present invention, the bridge structure 6 includes a shielding film 61 and a conductive wire 62. The shielding film 61 is made of a material of highly transparent insulated thin film with permittivity of 2 to 4 such as ink or PET. The shielding film 61 will cover at least partially an area between two adjacent induction-spots 22a of one Y axis trace. Furthermore, at least two through holes 61a and 61b are formed on the shielding film 61 respectively onto the adjacent induction-spots 22a. The conductive wire 62 is made of a transparent organic conductive material such as Indium Tin Oxide and PEDOT and is arranged on the surface of the shielding film 61. Furthermore, the conductive wire 62 crosses between the two through holes 61a and 61b. The two ends of the conductive wire 62 exposed to the through holes 61a and 61b respectively are formed as electrical joints 62a and b2b respectively. When the bridge structure 6 is arranged on the sensing layer 2, the shielding film 61 will be arranged between the two adjacent induction-spots 22a of one Y axis trace and cover and insulate the X axis trace 21b which is located between the two adjacent induction-spots 22a of the Y axis trace. Furthermore, the electrical joints 62a and 62b on the two ends of the conductive wire 62 will connect the two adjacent induction-spots 22a through the through holes 61a and 61b respectively so that all the induction-spots 22a of each Y axis trace 22 are connected by the bridge structures.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A capacitive touch panel having a substrate layer, a sensing layer and a surface layer, a sensing layer and a surface layer being made of transparent material and being glued together as a transparent panel; a plurality of X axis traces and a plurality of Y axis traces being intersected each other and arranged on the sensing layer so as to form as a matrix on the sensing layer; a front end of each X trace and each Y trace having a joint which is connected to a sliver conducting wire at edges of the panel and is conducted to a signal output wire bank; therefore, an output signal of the touch panel being transferred through the signal output wire bank to a succeeding signal processing circuit;
wherein the plurality of X axis traces and Y axis traces are arranged at the same plane; each X axis trace includes a plurality of induction-spots and each Y axis trace includes a plurality of induction-spots; the induction-spots of one X axis trace are connected one by one, while the induction-spots of one Y axis trace are connected by a bridge structure running through a respective one of the plurality of X axis traces and the induction-spots of the Y axis trace is insulated to the respective one of the plurality of X axis trace.

2. A capacitive touch panel as claimed in claim 1, wherein the bridge structure includes a shielding film and a conductive wire; the shielding film is an insulated thin film, and the shielding film will cover at least an area of the X axis trace between the two adjacent induction-spots of one Y axis trace; the conductive wire is arranged on the surface of the shielding film; both ends of the conductive wire extend outside the shielding film to the adjacent induction-spots respectively and form as electrical joints; by the shielding film arranged between the two adjacent induction-spots of the Y axis trace, the X axis trace which passes between the two adjacent induction-spots of the Y axis trace will be covered and insulated; and the electrical joints on the two ends of the conductive wire will connect the two adjacent induction-spots respectively so as all the induction-spots of each Y axis trace are connected by the bridge structures.

3. A capacitive touch panel as claimed in claim 1, wherein the bridge structure includes a shielding film and a conductive wire; the shielding film is an insulated thin film; and the shielding film will cover at least partially any two adjacent induction-spots of each Y axis trace; furthermore, at least two through holes are formed on the shielding film respectively to the adjacent induction-spots; the conductive wire is arranged on a surface of the shielding film and crosses a position between the two through holes; both ends of the conductive wire exposed to the through holes respectively are formed as electrical joints; by the shielding film arranged between the two adjacent induction-spots of one Y axis trace, the X axis trace which passes between the two adjacent induction-spots of the Y axis trace will be covered and insulated; and the electrical joints on the two ends of the conductive wire will be connected to the two adjacent induction-spots through the through holes respectively so that all the induction-spots of each Y axis trace are connected by the bridge structures.
